(19) United States
(12) Patent Application Publication
(10) Pub. No.: US 2021/0184400 A1
(43) Pub. Date: Jun. 17, 2021

(54) LOCK FOR PLUG-IN CONNECTOR

(71) Applicant: Phoenix Contact GmbH & Co. KG, Blomberg (DE)

(72) Inventor: Karsten Krome, Detmold (DE)

(21) Appl. No.: 16/761,502

(22) PCT Filed: Oct. 26, 2018
(86) PCT No.: PCT/EP2018/079363

§ 371 Date: May 5, 2020

(30) Foreign Application Priority Data
Nov. 7, 2017 (DE) 10 2017 125 915.5

(51) Int. Cl. H01R 13/627

(52) U.S. Cl. CPC H01R 13/6277

(57) ABSTRACT

A plug-in connector part connectable to a mating connector part so as to form a plug-in connection includes: a housing; and an elastically deformable locking component embodied separately from the housing, which reversibly locks to a locking contour of the mating connector part during a creation of the plug-in connection. The locking component is at least partially arranged in the housing of the plug-in connector part and has a section that is curved around a longitudinal axis of the plug-in connector part, which is parallel to the plug-in direction, and has at least one locking region and at least one unlocking region. The locking component is prestressed in a closed position and is elastically radially outwardly expandable into an open position in the locking region by an action of a radially inwardly oriented force on the unlocking region.

### CROSS-REFERENCE TO PRIOR APPLICATIONS

This application is a U.S. National Phase application under 35 U.S.C. § 371 of International Application No. PCT/EP2018/079363, filed on Oct. 26, 2018, and claims benefit to German Patent Application No. DE 10 2017 125 915.5, filed on Nov. 7, 2017. The International Application was published in German on May 16, 2019 as WO 2019/091795 under PCT Article 21(2).

### FIELD

The invention relates to a plug-in connector part that can be connected to a mating connector part so as to form a plug-in connection.

### BACKGROUND

Such a plug-in connector part is used for connecting line ends, in particular electrical lines.

Such a plug-in connector part comprises a housing and an elastically deformable locking component, which is embodied separately from the housing and is designed to reversibly engage with a locking contour of the mating connector part when the plug-in connection is formed.

In conventional plug-in connector parts of this type, as described in DE 2 323 180, the plug-in connector part and the mating connector part have different parts of an annular groove on the inside of their housings, which parts align with one another when the plug-in connection is formed and thus form a continuous annular groove. A snap ring is then inserted into the annular groove in order to interlock the plug-in connection. In these plug-in connector parts, the fact that the snap ring is provided separately from a housing of the plug-in connector part can result in disadvantages. This can make handling them more difficult. In addition, there is increased risk of loss of the snap ring. In addition, the snap ring surrounds the plug-in connector part on an outer side of the housing, so that the snap ring is exposed to weathering and corrosion without protection, and thus the service life of the plug-in connector part can be shortened.

Other plug-in connector parts reduce the aforementioned problems by having, instead of a snap ring, a plastic housing with one or more latching elements formed thereon which detachably engage with corresponding latching receptacles in a plastic housing of the mating connector part. However, the deformation of the latching elements required in this method places high mechanical stresses on the housing material, which must often also satisfy electrical and environmental requirements. These requirements on the housing material are often quite difficult to fulfill simultaneously.

Therefore, there is a need for a plug-in connector part that alleviates or avoids the aforementioned problems.

### SUMMARY

In an embodiment, the present invention provides a plug-in connector part connectable to a mating connector part so as to form a plug-in connection, comprising: a housing; and an elastically deformable locking component embodied separately from the housing, which is configured to reversibly lock to a locking contour of the mating connector part during a creation of the plug-in connection, wherein the locking component is at least partially arranged in the housing of the plug-in connector part and has a section that is curved around a longitudinal axis of the plug-in connector part, which is parallel to the plug-in direction, and has at least one locking region and at least one unlocking region, and wherein the locking component is prestressed in a closed position and is elastically radially outwardly expandable into an open position in the locking region by an action of a radially inwardly oriented force on the unlocking region.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1: A schematic representation of a perspective view of a plug-in connector part in accordance with an exemplary embodiment;

FIG. 2A: A schematic representation of a cross-sectional view of a plug-in connector part when the locking component is in the closed position;

FIG. 2B: A schematic representation of a cross-sectional view of a plug-in connector part when the locking component is in the open position;

FIG. 3A: A schematic representation of a cross-sectional view of a plug-in connector part when the locking component is in the closed position according to a further exemplary embodiment;

FIG. 3B: A schematic representation of a cross-sectional view of a plug-in connector part when the locking component is in the open position according to a further exemplary embodiment;

FIG. 4 A schematic representation of a perspective view of a mating connector part according to an example;

FIG. 5 A schematic representation of a side view of a plug-in connector according to an exemplary embodiment;

FIG. 6 A schematic representation of a perspective view of two plug-in connectors according to a further exemplary embodiment with a tool inserted into the housing from different directions.

### DETAILED DESCRIPTION

In an embodiment, the locking component is at least partially arranged in the housing of the plug-in connector part and has a section which is curved around a longitudinal axis of the plug-in connector part which is parallel to the plug-in direction and has at least one locking region and at least one unlocking region. The locking component is prestressed when in a closed position and can be elastically expanded in a radially outward direction into an open position in the locking region by the action of a radially inward force on the unlocking region.

The locking component can be designed such that, when the plug-in connection is formed and before engagement, it expands elastically into the open position in the locking region by means of the locking contour of the mating connector part. In this case, the locking component can have a beveled profile in the locking region.

When in the prestressed position, the locking component can have a greater curvature in the unlocking region than in the locking region. In the open position, the curvature of the locking component in the locking region can be increased relative to the closed position. In the open position, the curvature of the locking component in the unlocking region can also be reduced relative to the closed position.

The locking component can be at least essentially annular. In this case, the locking component can be at least essentially oval. In addition, one unlocking region can be arranged in each case at the vertices of a long diameter of the locking component in each case and one locking region can be arranged in each case at the vertices of a short diameter of the locking component.

Alternatively, the locking component may be circular. In a further alternative, the locking component can be arc-shaped. The locking component can further be arranged concentrically to the longitudinal axis of the plug-in connector part in the housing. Alternatively, the locking component can be arranged eccentrically to the longitudinal axis of the plug-in connector part in the housing.

The housing of the plug-in connector part can at least essentially enclose the locking component in the radial direction. In addition, the housing of the plug-in connector part can have housing openings near the unlocking region of the locking component, which allow the insertion of a tool for exerting a radially inward force on the unlocking region. In this case, the housing can have a plurality of openings near the unlocking region, which permit insertion of the tool from different directions.

Alternatively, the housing of the plug-in connector part may incompletely enclose the locking component near the unlocking region. The housing can be designed in such a way that the manual, tool-free exertion of a radially inward force on the unlocking region is possible. In this case, when in the closed position, the locking component can protrude beyond an outside of the housing through one or more openings in the housing near the unlocking region.

In a region which engages with the mating connector part, the housing of the plug-in connector part can have an at least essentially rotationally symmetrical form around a longitudinal axis parallel to the plug-in direction.

The housing of the plug-in connector part and the locking component may comprise materials different from each other. In this case, the housing of the plug-in connector part can comprise a more rigid material than the locking component. The housing of the plug-in connector part may comprise plastic. The locking component may comprise a less rigid plastic than the housing and/or a flexible metal.

In another aspect, a plug-in connector is presented. The plug-in connector comprises a plug-in connector part of the type presented here and a mating connector part, to which the plug-in connector part can be reversibly connected to form a plug-in connection.

The locking contour of the mating connector part may comprise an annular groove. The locking contour can additionally have a protruding region.

The locking contour of the mating connector part may have a beveled region. The beveled region may be arranged in the protruding region of the locking contour.

In a region which engages with the housing of the plug-in connector part, the mating connector part can have an at least essentially rotationally symmetrical form around a longitudinal axis parallel to the plug-in direction.

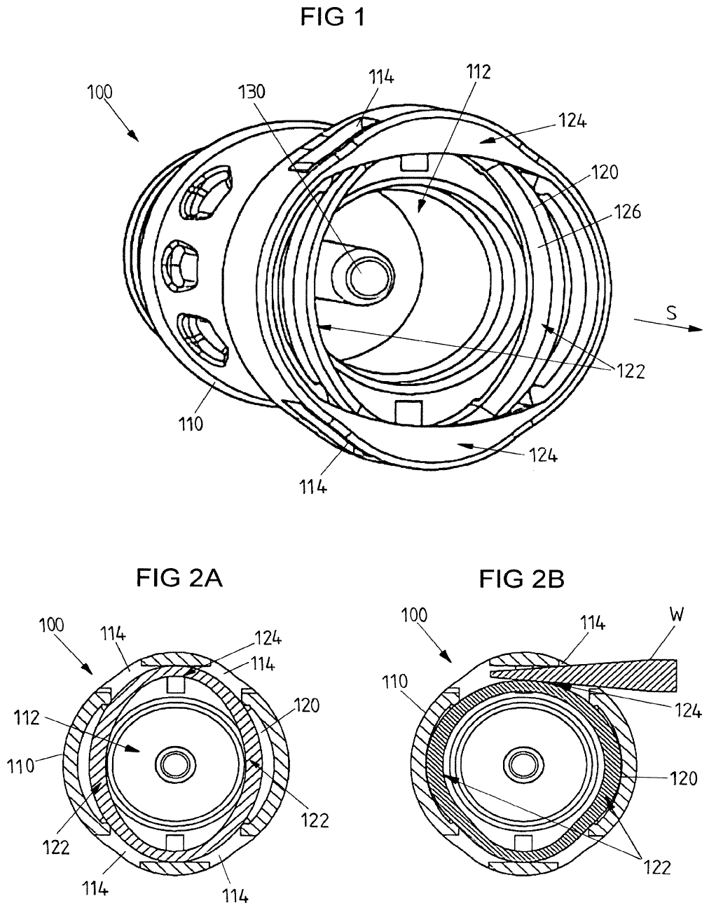

FIG. 1 shows a schematic representation of a perspective view of a plug-in connector part 100. The plug-in connector part 100 is provided for forming a plug-in connection with a mating connector part. The plug-in connector part 100 comprises a housing 110 having a housing region 112 that engages with the mating connector part. In the example shown, the housing region 112 that engages with the mating connector part is designed rotationally symmetrically around a longitudinal axis of the plug-in connector part 100 parallel to the plug-in axis S. The housing 110 surrounds an electrical contact region 130 of the plug-in connector part 100, which is provided for making contact with a mating contact region of the mating connector part. In the example shown, the housing 110 also comprises a plurality of housing openings 114.

The plug-in connector part 100 further comprises a locking component 120 formed separately from the housing 110 for reversibly locking a plug-in connection to a mating connector part. For this purpose, the locking component 120 comprises a plurality of locking regions 122 and a plurality of unlocking regions 124. The locking component 120 also has a beveled profile 126 in the locking regions 122.

The plug-in connector part 100 is designed to form a plug-in connection with a mating connector part, for example, the mating connector part 400 as shown in FIG. 4, as will be described in more detail below. To this end, the locking component 120 is elastically deformable and prestressed in a closed position. When a mechanical force acts in one or both of the unlocking regions 124 in a direction pointing radially inward to the longitudinal axis of the plug-in connector part 100, the locking component 120 is elastically deformed in such a way that the curved locking component 120 is widened in the locking regions 122 and thus transitions into an open position. In the mating connector part 400 in FIG. 4, for example, each of the locking regions 122 protrudes into an annular groove 420 of the mating connector part 400 when a plug-in connection is established and the locking component 120 is in the closed position. In this way, the mating connector part 400 is held in the connected position and the plug-in connector is locked to it. On the other hand, if the locking component 120 is expanded in the locking regions 122, for example as a result of a force acting on one or both of the unlocking regions 124, the locking regions 122 are moved out of the annular groove 420 of the mating connector part 400 and the plug-in connection is thereby detachably unlocked.

The beveled profile 126 of the locking component 120 in the locking regions 122 aids the formation of a plug-in connection without the locking component 120 initially being required for this through exertion of a force on the unlocking region or regions 124 for opening the locking component 120. In particular, the beveled profile 126 promotes bending of the locking component 120 by a locking contour of the mating connector part when the plug-in connection is formed.

In the example shown, the locking component 120 is embodied as annular, in particular essentially oval. In this case, the unlocking regions 124 are each located at a vertex of the long diameter of the oval, while the locking regions 122 are each located at a vertex of the short diameter of the oval. The locking component 120 is also arranged concentrically to the longitudinal axis of the plug-in connector part 100. The plug-in connector part 100 is further arranged in the housing 110 in such a way that the housing openings 114 are each located near one of the unlocking regions 124 of the locking component 120.

In the example shown in FIG. 1, the housing 110 encloses the locking component 120 in the radial direction. In this way, tool-free manual access to the unlocking regions 124 of the locking component 120 is prevented, avoiding, for example, an inadvertent or unintentional release of the plug-in connection. At the same time, the locking component 120 is effectively protected against external influences such as weather or UV radiation. This effectively increases the service life of many elastic materials usable for the locking component 120, such as an elastic plastic or a flexible metal.

At the same time, the housing openings 114 allow the insertion of a tool, for example a screwdriver, in approximately the tangential direction to the longitudinal axis of the plug-in connector part 100 so as to exert a radially inward force on the unlocking regions 124. In some examples, the locking component 120 is formed so as to be sufficiently strongly deformed with respect to a provided mating connector part 400 to already to reach the open position through exertion of a force on only one of the unlocking regions 124.

The housing 110 also partially encloses the locking component 120 in the axial direction. This prevents the locking component 120 from falling out of the housing and thus in particular prevents the locking component 120 from being lost. In other examples, the locking component 120 is secured against loss by other means. For example, it can be fastened to the housing 110 at one or more connection points.

Given that the housing 110 and the locking component 120 are formed separately, the plug-in connector part 100 favors the use of different materials for the housing 110 and the locking member 120. In particular, a more rigid and weatherproof material can be used for the housing 110 than for the locking component 120, corresponding to the different functional requirements of the housing 110 and the locking component 120. At the same time, as described above, the service life of the locking component 120 is also increased by its arrangement within the housing 110. This particularly applies when typically weather-sensitive elastic materials are used for the locking component 120.

The invention has been described above using the example of a plug-in connector part 100 having a rotationally symmetrical region 112 which engages with the mating connector part and a centrally arranged, closed annular, in particular oval, locking component 120. However, it goes without saying that the described advantages can also be achieved with embodiments of the plug-in connector part 100 that differ from this. Specifically, a connecting region of the plug-in connector part 100 is not rotationally symmetric in other examples. In addition, in further examples, the locking component 120 is circular. In still further examples, the locking component 120 is arc-shaped, so that it describes a part of a ring, for example a part of an oval. In this case, the locking component 120 has, for example, a number that deviates from two unlocking regions 124 and two locking regions 122 for at least one of these types of regions. What these examples have in common is that the locking component has at least one curved section having at least one unlocking region and at least one locking region and is designed such that, as a result of exertion of an inward force on the unlocking region, the curvature of the locking component is changed such that the locking region or regions is or are elastically moved with respect to a provided mating connector part 400 from a prestressed position corresponding to a closed position into a position corresponding to an open position.

FIG. 2A shows a cross-sectional view of the plug-in connector part 100. The cross-sectional plane lies in the region of the locking component 120. The same reference signs as in FIG. 1 denote the same features as described in connection with FIG. 1.

FIG. 2A shows the plug-in connector part 100 when the locking component 120 is in the closed position. In this case, the locking component 120 has a greater curvature in the unlocking regions 124 than in the locking regions 122. In addition, the locking component 120 extends closer to a longitudinal axis of the plug-in connector part 100 in the locking regions 122. In this case, the distance between each of the locking regions 122 and the longitudinal axis is less than the outer radius of a locking contour 420 of a provided mating connector part 400.

FIG. 2B shows another cross-sectional view of the plug-in connector part 100. The cross-sectional plane is the same as in FIG. 2A. In contrast to FIG. 2A, FIG. 2B shows the plug-in connector part 100 when the locking component 120 is in an open position.

A tool W, for example a screwdriver, is inserted into the housing 110 through one of the housing openings 114. In this case, a radially inward force is exerted on the corresponding unlocking region 124. Aided by the shape of the housing 110, which prevents the locking component 120 from escaping as it would otherwise, the locking component 120 thus expands in the locking regions 122.

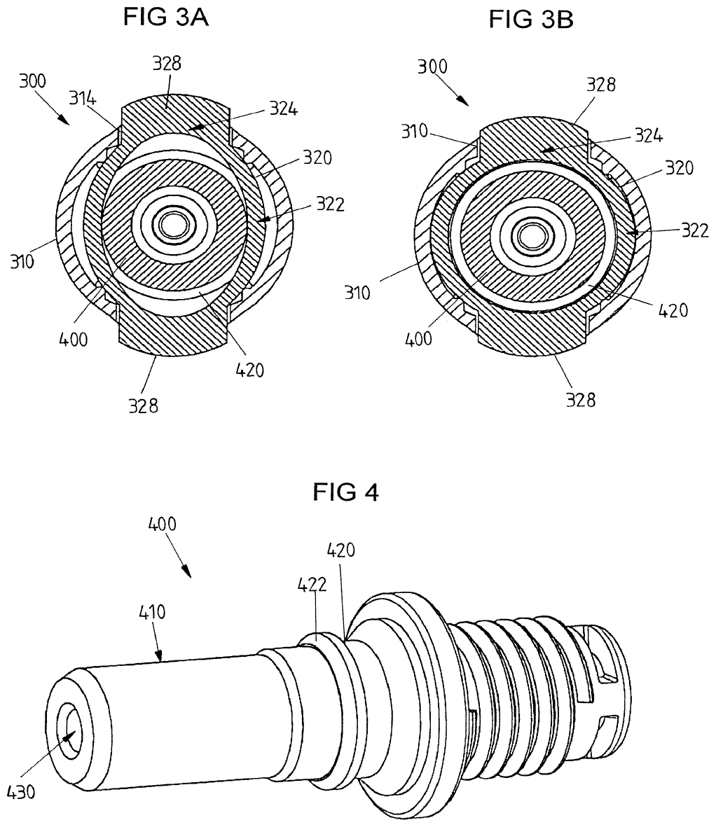

FIG. 3 shows a cross-sectional view of a plug-in connector part 300 according to another example. Unless otherwise stated below, the previous statements concerning the plug-in connector part 100 apply equivalently to the plug-in connector part 300. A mating connector part 400 that has formed a plug-in connection with the plug-in connector part 300 is also shown.

The plug-in connector part 300 comprises a housing 310 and a locking component 320 arranged at least essentially within the housing 310. The housing 310 has housing openings 314 through which the locking component 320 partially protrudes when in the closed position shown. In particular, operating regions 328 of the locking component 320 extend outwards through the housing openings 314 through an outside of the plug-in connector part 300. In the closed position shown, the locking regions 322 also extend into a locking contour 420, for example into an annular groove, of the mating connector part 400.

Unlike in the plug-in connector part 100 in FIG. 1, in the plug-in connector part 300, the locking component 320 is not completely enclosed by the housing 310 in the radial direction. The plug-in connector part 300 thus allows manual operation without tools. In particular, the locking component 320 can be opened by manually pressing on at least one of the operating regions 328.

FIG. 3B shows a further cross-sectional view of the plug-in connector part 300. The cross-sectional plane is the same as in FIG. 3A. In FIG. 3B, the locking component 320 is in the open position, which differs from the position shown in FIG. 3A. In this case, both operating regions 328 are pressed radially inward and consequently the locking component 320 is expanded as much as possible in the locking regions 322. As can be seen from FIG. 3B, unlike in the position in FIG. 3A, no region of the locking component 320 extends into the locking contour 420 of the mating connector part 400.

The plug-in connector part 300 provides reduced protection against unintentional or inadvertent operation compared to the plug-in connector part 100. In some examples, weather protection of the elastic parts of the locking component 320 is also less than in plug-in connector part 100. Nevertheless, even in plug-in connector part 300, the housing still offers extensive protection for the locking component, while at the same time facilitating operation this is simpler, in particular without tools.

FIG. 4 shows a schematic representation of a perspective view of a mating connector part 400. The mating connector part 400 is designed, for example, to form a plug-in connection with a plug-in connector part 100, 300 as described above. To this end, the mating connector part 400 has a region 410 which engages with the housing of the plug-in connector part and a locking contour 420 to lock the plug-in connection. For this purpose, the locking contour 420 is designed for a locking component of the plug-in connector part to engage with the locking contour 420. The mating connector part 400 further comprises a mating electrical contact area 430 for making contact with a suitable contact area, for example the contact area 130 of the plug-in connector part 100, when a plug-in connection is established.

In the example shown, the region 410 that engages with the housing of the plug-in connector part along with the locking contour 420 are formed in a rotationally symmetric manner. This makes it possible, for example, for the connected plug-in connector parts to be rotatable relative to one another around a longitudinal axis of the plug-in connection when the plug-in connection is established. The mating connector part 400 also has a beveled region 422 in the region of the locking contour 420. Similarly as described for the beveled profile 126 of the plug-in connector part 100, the beveled region 422 facilitates the expansion of the locking component by the locking contour 420 when the plug-in connection is formed.

FIG. 5 shows a schematic representation of a side view of a plug-in connector 500. The plug-in connector 500 comprises a plug-in connector part 300 as described in connection with FIGS. 3A and 3B and a mating connector part 400 as described in connection with FIG. 4. FIG. 5 shows the plug-in connector 500 in a connected position. In this case, the locking component of the plug-in connector part 300 is also in the closed position, as can be seen from the operating regions 328 protruding beyond the outside of the housing.

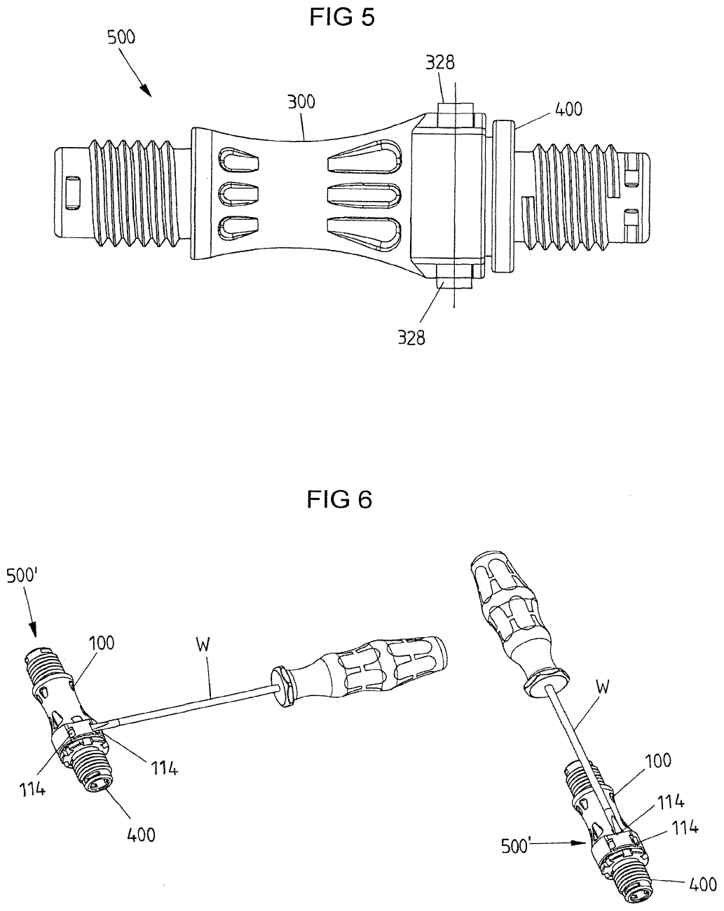

FIG. 6 shows a schematic representation of a perspective view of two plug-in connectors 500′ according to another example. Unlike the plug-in connector 500, the plug-in connectors 500′ comprise a plug-in connector part 100 as described in connection with FIG. 1 in addition to a mating connector part 400 in each case. In addition, a tool W, a screwdriver in each of the examples shown, is inserted into a housing opening 114 in each of the plug-in connectors 500′. As a result, in both plug-in connectors 500′, the plug-in connector 100 is in an open position as described in connection with FIG. 2B. Additionally or alternatively to the depicted housing openings 114 and possible insertion directions of the tool W, other examples of the plug-in connector 500 have further or different housing openings 114 that allow the insertion of a tool from further or different directions.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100, 300-Plug-in connector part
110, 310-Housing
112-Housing region that engages with mating connector part
114, 314-Housing opening
120, 320-Locking component
122, 322-Locking region
124, 324-Unlocking region
126-Beveled profile of locking component
130-Contact area
328-Operating region
400-Mating connector part
410-Region that engages with housing of plug-in connector part
420-Locking contour (420)
422-Beveled region
430-Mating contact area
500, 500′-Plug-in connectors
S-Plug-in direction
W-Tool

1. A plug-in connector part connectable to a mating connector part so as to form a plug-in connection, comprising:
a housing; and
an elastically deformable locking component embodied separately from the housing, which is configured to reversibly lock to a locking contour of the mating connector part during the a creation of the plug-in connection,
wherein the locking component is at least partially arranged in the housing of the plug-in connector part and has a section that is curved around a longitudinal axis of the plug-in connector part, which is parallel to the plug-in direction, and has at least one locking region and at least one unlocking region, and
wherein the locking component is prestressed in a closed position and is elastically radially outwardly expandable into an open position in the locking region by an action of a radially inwardly oriented force on the unlocking region.

2. The plug-in connector part according to claim 1, wherein the locking component is configured to expand elastically into the open position in the locking region by the locking contour of the mating connector part when the plug-in connection is formed and before engagement.

3. The plug-in connector part according to claim 2, wherein the locking component has a beveled profile in the locking region.

4. The plug-in connector part according to claim 1, wherein, in the prestressed position, the locking component has a greater curvature in the unlocking region than in the locking region.

5. The plug-in connector part according to claim 1, wherein, in the open position, the curvature of the locking component in the locking region is increased relative to the closed position and the curvature of the locking component in the unlocking region is reduced relative to the closed position.

6. The plug-in connector part according to any of the claim 1, wherein the locking component is of at least essentially annular.

7. The plug-in connector part according to claim 6, wherein the locking component is at least essentially oval and one unlocking region is arranged at vertices of a long diameter of the locking component in each case and one locking region is arranged at vertices of a short diameter of the locking component in each case.

8. The plug-in connector part according to claim 1, wherein the housing of the plug-in connector part at least essentially encloses the locking component in a radial direction and has housing openings near the unlocking region of the locking component, which openings allow insertion of a tool for exerting a radially inward force on the unlocking region.

9. The plug-in connector part according to claim 1, wherein the housing of the plug-in connector part incompletely encloses the locking component near the unlocking region, so as to permit a manual, tool-free exertion of a radially inward force on the unlocking region.

10. The plug-in connector part according to claim 1, wherein, in a region that engages with the mating connector part, the housing of the plug-in connector part; has an at least essentially rotationally symmetric shape around a longitudinal axis parallel to the plug-in direction.

11. The plug-in connector part according to claim 1, wherein the housing of the plug-in connector part and the locking component comprise materials different from one another.

12. A plug-in connector, comprising:
the plug-in connector part according to claim 1: and a mating connector part, to which the plug-in connector part is reversibly connectable to form the plug-in connection.

13. The plug-in connector according to claim 12, wherein a locking contour of the mating connector part comprises an annular groove.

14. The plug-in connector according to claim 12, wherein a locking contour of the mating connector part has a beveled region.

15. The plug-in connector according to claim 12, wherein, in a region that engages with the housing of the plug-in connector part, the mating connector part has a shape which is at least essentially rotationally symmetric around a longitudinal axis parallel to the plug-in direction.
